(19) United States
(12) Patent Application Publication
(10) Pub. No.: US 2007/0105229 A1
(43) Pub. Date: May 10, 2007

(54) Authentication of packaged articles

(76) Inventors: Carolyn A. Burns, Hockessin, DE (US); Mark Ralph Miller, Avondale, PA (US); Laurie K. Williams, Newark, DE (US); Poruri Govindanarayana, Mumbai (IN); Sumarno Kartolo, Taoyuan (TW); Georg Bauer, Salzburg (AT); Jeffrey Allen Chambers, Hockessin, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/506,261

(22) Filed: Aug. 18, 2006

Related U.S. Application Data
(60) Provisional application No. 60/709,874, filed on Aug. 19, 2005.

(51) Int. Cl. G01N 37/00

(52) U.S. Cl. 436/56

(57) ABSTRACT

Disclosed is a package comprising a film that reflects varying wavelengths of light, wherein the wavelength of the reflected light depends upon the angle of incident light striking said film at its surface.

The application claims priority to U.S. provisional application, No. 60/709,874, filed Aug. 19, 2005, the entire disclosure of which is incorporated herein by reference.

The invention relates to an article comprising an authentication marker and method for detecting the occurrence of fraud in transactions involving articles.

### BACKGROUND

To prevent fraud during the conduct of commerce, it is conventional to mark products in some manner to identify the product and/or verify that the product is authentic and has been made and/or sold legally. Legitimate businesses such as manufacturers, suppliers, distributors, and/or vendors are concerned with the growth of various fraudulent practices in commercial transactions. Examples of fraudulent practices that are of concern to legitimate businesses include: diversion; dilution; and counterfeiting. Perpetrators of fraud (hereinafter, predators) use illicit tactics to divert profits from legitimate business concerns, and these tactics can also include theft of the authentic goods.

For example, diversion is a practice whereby authentic product is diverted from being sold in a market in which the product was intended to be sold at a low market value, but is rerouted by a predator to another market where the product can be sold at a higher market value. Often the market of lower value is a market that is one that is needy but unable to pay the higher market value. For example, pharmaceuticals intended for a poor country can be repackaged and sold in another market at a high profit margin to the predator. Diverted product thus can re-route profits from the legitimate business concern to the predator while at the same time depriving a poor population of needed goods. Dilution is a fraudulent practice whereby an authentic product is mixed with an inactive ingredient and the product is represented as being identical to an unmixed product. Counterfeiting is producing a copy of an original product and passing it off as an authentic original product, that is, the product that was copied.

Marking include overt methods, whereby the marked item is identified in such a manner as to make it apparent to an observer (customer, merchant, predator, or the like) that the item is in fact marked. An overt mark is one that provides easily accessible or readily displayed information about the authenticity of the product to the principals in the transaction. The overt marking can be a visual design that is so unique that it will be apparent that the item is authentic, or a mark that will provide product information to a sensing or signal reading device. Overt markings can include, for example, bar codes on the external surface of the marked product, fluorescent ink or pigments easily visible to the naked eye; holograms; trademarks; logos; labels; and unique color schemes to discourage fraud. U.S. Pat. No. 6,351,537 B1 discloses a product having an overt verifiable holographic image.

Covert marking is a marking practice wherein a product is marked using an identifier that is not easily seen by a consumer. For example, covert markings can be placed below the surface of a product such that it is hidden from sight, or positioned on the inside of a container, or provided in a form that is not readily distinguishable from other components or features of the product being marked, or the marker can be of a type that can only be identified with the aid of a “reading” device. The reading device has a display that can instantly provide overt information acquired from the covert marker and thereby verify the authenticity of the product at the time of the transaction. Using a covert marker can stifle attempts by a predator to take steps to disable or otherwise defeat purpose of the marker. A covert method for detection of fraud is disclosed in U.S. Pat. No. 6,442,276. US Application 2004/0026917 discloses optical shifting technology as applied to thin films for deterrence of fraud.

In the conduct of business transactions wherein authenticity of goods can be an issue, it can be desirable to provide an article comprising markers that can be readily used to provide covert historical data on the occurrence of fraud for a particular product, detect illicit products immediately at the point of transfer, eliminate predatory fraudulent activity with respect to a particular product.

### SUMMARY OF THE INVENTION

The invention provides an article or package comprising an authentication marker wherein the article includes an induction seal, a tear tape, a blisterpack, a neck band, a shrink sleeve, the shrink sleeve, or combinations of two or more thereof; the marker is optionally incorporated in or on a film; and the marker or the film reflects varying wavelengths of light and the wavelength of the reflected light depends upon the angle of incident light striking the film at its surface.

### DETAILED DESCRIPTION OF THE INVENTION

An article comprising an authentication marker can be any article that can be packaged and used in conducting commercial transactions such as any manufactured article, currency, a document, artwork, a bank draft (check), a license, and the like. The article can be sealed and/or packaged. An overt marker can be placed on, included with, incorporated onto or into an article.

An authentication marker can comprise or be included in at least one aspect of color shifting film (CSF) to provide information about the authenticity of the article. Color shifting technology refers to technology that creates an optical effect whereby the wavelength of light that is reflected from a surface varies depending upon the angle at which the reflected light is being detected. For example, an article comprising a CSF can appear to be red, blue, green, violet, yellow, or various other colors depending on the angle that light strikes the surface and is reflected from the surface. CSF can be incorporated into a package as a film layer, a strip of film or a band in a package, or an imprinted design and used to form inner seals and/or outer seals individually or in combination with other technologies.

Color shifting technology can be compatible for use with induction heat sealing, for example. Other methods of incorporating color shifting technology can be envisioned by one skilled in the art of packaging, branding, and or security for manufactured articles.

Markers can include, for example, visible holograms, trademarks, trade symbols, visible bar codes, chromagraphic images or displays, serial numbers, and company names. The film having incorporated therein or thereon an authentication marker can be used as CSF disclosed above.

The film can comprise or be produced from an ethylene copolymer, a polyolefin such as polyethylene or polypropylene, polycarbonate, polyurethane, polyimide, polystyrene, polyester, polyamide, polymethacrylate, or combinations of two or more thereof. An ethylene copolymer can comprise repeat units derived from ethylene, carboxylic acid or derivative, and optionally a comonomer; an ionomer of the ethylene copolymer; or combinations thereof. Because such films are well known to one skilled in the art, the description of which is omitted herein for the interest of brevity.

The film may also contain components such as ultraviolet stabilizer, light stabilizer, antioxidant, thermal stabilizer, pigment, dye, filler, anti-slip agents, plasticizers, nucleating agents, flow modifier, or combinations of two or more thereof for both polyamide and ionomer. These components may be present in amounts of about 0.0001 to about 3 or about 0.001 to about 3 wt %.

The marker can be or comprise metallic or non metallic nanoparticles having a size < about 100 nm, < about 80 nm, or < about 50 nm, either spread over the film or incorporated as metal cluster lumping together with a size of < about 5 nm, < about 2 nm, or < about 1 nm. The metallic nanoparticles can be aluminum, chromium, gallium, indium, telluride, germanium, tin, antimony, a transition metal, or combinations of two or more thereof where the transition metal can be iron, cobalt, nickel, copper, silver, gold, platinum, or combinations of two or more thereof. The nanoparticles can also be a compound of one or more metals disclosed such as metal oxide, metal halide, metal carboxylate, metal nitrite, metal carbide, or even silicon oxide, silicon carbide, silicon nitrite, or combinations of two or more thereof. The incorporation of metallic nanoparticles can be carried out by any means known to one skilled in the art such as, for example, deposition, coating, dispersion, impregnation, lamination, or solubilization of the metallic particles. Frequently carried out is coating or deposition such as vacuum coating or vacuum deposition.

The film can also be transmissive for electromagnetic waves.

If the film is a multilayer film, the metallic nanoparticles can be present in one or more layers. For example, a film having incorporated therein metallic nanoparticles can be an inner layer of a multilayer film that can be made by lamination or coextrusion. A multilayer film can further comprise an outer or surface layer, which can comprise a polyolefin polyethylene or polypropylene, polycarbonate, polyurethane, polyimide, polystyrene, polyester, polyamide, polymethacrylate, or combinations of two or more thereof.

A film incorporated with the metallic nanoparticles can also comprise or be coated onto a substrate by, for example, extrusion coating, extrusion lamination, coextrusion coating, or coextrusion lamination such that the film can become rigid or semi-rigid. Such substrate can include paper, paper board, or metal film (e.g., aluminum foil).

The film can have any thickness so long as the film can reflect different wavelengths of light depending on the angle of incident light striking the film at its surface. The thickness can be from about 0.001 mm to about 10 mm or about 0.01 mm to about 5 mm, or about 0.1 mm to about 2 mm.

The film can be made by any means known to one skilled in the art. For example, a multilayer film can be made by laminating a film comprising the metallic nanoparticles to another layer of film or a substrate by means of an inner layer applied in molten form to adhere the film to the substrate. Also for example, one of the layers can be made from a material with anisotropic refractive index such as, for example, liquid-crystal polymers which show a characteristic coloration both at different observation angles (angles relative to the z axis) and at different rotation angles (angles in the x-y plane). One of the layers may also be made from a material having optical properties that can be deliberately modified after the layer is applied such as, for example, a photosensitive polymer having refractive index changeable by illumination.

An induction seal material comprising a CSF disclosed above can be useful in providing a positive seal against intrusion of unwanted materials such as foreign matter, oxygen, moisture, air, organic vapor, or combinations of two or more thereof into a container containing the induction seal, while still providing easy access to the contents when desired. An example of an induction-sealed container is often found sealed to the mouth of over-the-counter pharmaceutical bottles or vials.

An induction seal can be produced by any means known to one skilled in the art such as, for example, by laminating a CSF disclosed above with a substrate such as a 25 μm layer of soft aluminum using adhesive means. This laminate can be coated with a thermoplastic sealant layer including an ethylene copolymer disclosed above. Such thermoplastic sealant resin is commercially available such as Appeel® or Bynel®, E. I. du Pont de Nemours and Company, Wilmington Del. (DuPont). For example, Bynel ® grade 2002, which had a melting temperature of about 91° C. and melt flow of about 10 g/10 min, provides a satisfactory seal. Aluminum substrate can be coated on the side away from the sealant layer with a low melting wax. The substrate can be further laminated to a cap lining material such as an absorbent cardboard or a polyolefin foam followed by die-cut into a subassembly of a desired dimensions to fit inside the cap of a container such as bottle as to serve as a cap liner. To create a color shifting of an induction sealed container, the subassembly can be placed inside the cap of a container. Container can also include jar, can, box, cup, or vial.

For example, the cap of a container such as bottle can comprise or be produced from a polymer including a polyolefin such as polypropylene or polyethylene, polyester such as polyethylene terephthalate, or ethylene copolymer such as ethylene (meth)acrylate copolymer or ethylene(meth)acrylic acid copolymer or ionomer of ethylene(meth)acrylic acid copolymer. The container can be then exposed to a radio frequency field (RF) inducing heating in the aluminum layer of the subassembly to raise the temperature of the sealant layer above its activation temperature and created a seal between the container and the induction seal. Simultaneously or subsequently, a melted wax layer can be absorbed into the absorbent cap liner, thereby separating the subassembly into two pieces, one of which can stay with the cap when opened, and the other remaining sealed to the bottle. The RF can be generated by any means known to one skilled in the art. Generally, a dwell time of about 1 to about 10 seconds such as about 3.5 seconds on the low RF power setting produces a strong seal with no thermal visible damage to the CSF.

A tear tape, also referred to as tear strip, comprising CSF includes a plastic strip or tape which can be sealed to a package to assist opening the package. A package can include plastic film overwraps, shipping envelopes, or combinations of two or more thereof.

For example, a tear tape comprising a CSF disclosed above can be slit to a width of about 0.1 to about 50, about 0.5 to about 20, or about 1 to about 10 mm and then bonded by an adhesive means onto a packaging film or a notch sensitive packaging film comprising a polyolefin such as polypropylene or polyethylene, polyester such as polyethylene terephthalate in such a manner as to be present on the final packaged article in a position for opening the package. This length of tape is designed such that pulling on the end of the tape creates an easily propagated continuous tear in the packaging film, facilitating opening of the packaged article. Such tear tapes can be applied to packaging films by means of a tear tape applicator such as the Supastrip Dispenser Model MB29 from Payne Worldwide of Colonial Heights, Va.

A blister pack is a package comprising a clear plastic shape into which is placed an article or product of manufacture wherein the plastic shape is subsequently joined to a backing card or film. A blisterpack generally comprises a clear thermoformable film that can be thermoformed to create indentations of suitable dimensions to hold an article, such as a pill, thermally bonded to a coversheet that can be torn off to access the enclosed product. Thermoformable films are available from Perlin Converting LLC of Whippany, New Jersey, under the trademark Perlalux®. The cover sheet can comprise a multilayer structure that may include a thermoplastic adhesive on a foil or film to provide oxygen or vapor barrier properties, and a printable surface such as paper.

A blisterpack comprising CSF can be obtained, for example, by applying a thermoplastic adhesive disclosed above to the surface of the CSF that does not comprise the authentication marker. A CSF can be incorporated into a blisterpack by attaching the thermoplastic adhesive coated CSF to either the clear thermoplastic film or the coversheet material in such a manner that the CSF reposes between the clear film and the coversheet. Optionally, once attached to either sheet, any protective film carrying the authentication marker can be removed by peeling. The CSF can also be encapsulated into a blisterpack during the thermal bonding cycle that seals the cover sheet to the clear thermoformable film. Cycle times of about one second at temperatures of 200° C. can yield successful results. Suitable blisterpack forming equipment are well known to one skilled in the art, for example, model HSA 50d available from Illig UK Ltd., Biggleswade, Bedfordshire, UK, can be used.

Neckbands can be useful in providing tamper evidence to a package. If the neckband is missing or damaged, one may presume that the container has been previously opened.

A neckband comprising CSF can be produced by, for example, applying a pressure sensitive adhesive to the surface of the CSF that does not comprise the authentication marker. Pressure sensitive adhesives are well known to one skilled in the art and can be commercially available from Henkel Corporation, Rocky Hill, Conn., such as their general purpose adhesive 30544. For convenient handling, a siliconized paper backing may also be applied over the pressure sensitive adhesive as a release layer. A neck label so fashioned can be applied over the cap of a bottle by equipment such as that available from Quadrel Labeling Systems of Mentor, Ohio, under the trademark of Versaline®.

A shrinkwrap and/or a shrink sleeve can be a package that comprises a thermoplastic film that shrinks when heated to fit tightly around an article of manufacture. In a variation, a shrink sleeve is open-ended on at least one end and comprises shrinkwrap material. Shrinkwrap materials can be useful in providing tamper evidence to a package because if the shrink wrap or sleeve is missing or damaged, one may presume that the package has been previously opened.

A shrink wrap or sleeve comprising CSF can be produced by, for example, bonding a CSF to a heat shrinkable film, that is well known to one skilled in the art. See, e.g., U.S. Pat. Nos. 1,876,067 and 3,048,954, the entire disclosures of which are incorporated herein by reference. For example, a coextruded, solvent sealable, heat shrinkable polyester film such as Mylar® D868 available from DuPont Teijin Films of Hopewell, Va., can be used. The outer surface layers of the film can comprise a polyester copolymer and are receptive to commonly used welding or sealing solvents for the manufacture of shrink sleeves, such as tetrahydrofuran. For a Mylar® D868 film having a thickness of about 2 mil (0.0051 cm), the shrinkage in the long or “hoop” direction can be in a range from 60 to 80% and the shrinkage perpendicular to the hoop direction can be in a range from 0 to 10%. Thermal shrinkage is determined by measuring the length and width dimensions of a film sample, immersing the sample in 100° C. (212° F.) water bath for about 30 minutes and then measuring the length and width to calculate the amount of film shrinkage. A sleeve or tube of the same film can be fashioned and applied over a container using a heat shrink film application device such as Model HAS-220 Sleeve Applicator from Tripack Corporation of Amherst, N.Y. Tubes of shrinkable film comprising CSF can be dropped over the container and passed through a steam tunnel or alternately, subject to streams of heated air, causing the shrinkable film to conform to the bottle. The conditions causing the film to shrink may depend on container configuration, line speed, tunnel temperature and whether the tunnel uses hot air or steam.

### EXAMPLE

An induction seal was obtained by laminating a color shifting film, such as those available from identif Technologies, Erlangen, Germany, with a 25 μm layer of soft aluminum, such as that available from Selig Sealing, Forrest, Ill., as Foilseal®, via adhesive means. This laminate product was further coated with a thermoplastic sealant layer (Appeel® or Bynel®; DuPont) for adhering to plastic substrates commonly used in pharmaceutical bottles. Bynel® grade 2002, which had a melting temperature of about 91° C. and melt flow of about 10 g/10 min, provided a satisfactory seal and was shown to avoid thermal damage to the color shifting film in induction sealing. In a further lamination step, the sealant-coated color shifting film with aluminum was coated on the side away from the sealant layer with a low melting wax and further laminated to a cap lining material (absorbent cardboard; Foilseal®). This assembly was die-cut into a sub-assembly of suitable dimensions to fit inside the cap of a bottle as to serve as a cap liner.

1. An article comprising an authentication marker wherein the article includes an induction seal, a tear tape, a blisterpack, a neck band, a shrinkwrap or shrink sleeve, or combinations of two or more thereof; the marker comprises metallic nanoparticles; and the marker reflects varying wavelengths of light and the wavelength of the reflected light depends upon the angle of incident light striking said film at its surface.

2. The article of claim 1 wherein the marker comprises a color shifting film.

3. The article of claim 2 wherein the film comprises or is produced from a polymer including ethylene copolymer, polyolefin, polycarbonate, polyurethane, polyimide, polystyrene, polyester, polyamide, polymethacrylate, or combinations of two or more thereof.

4. The article of claim 3 wherein the metallic nanoparticle includes aluminum, chromium, gallium, indium, telluride, germanium, tin, antimony, a transition metal, or combinations of two or more thereof.

5. The article of claim 3 wherein the transition metal includes iron, cobalt, nickel, copper, silver, gold, platinum, or combinations of two or more thereof.

6. The article of claim 1 wherein the marker is incorporated into or onto a film by deposition, coating, dispersion, impregnation, lamination, or solubilization.

7. The article of claim 4 wherein the marker is incorporated into or onto a film by deposition, coating, dispersion, impregnation, lamination, or solubilization.

8. The article of claim 1 wherein the article is the tear tape.

9. The article of claim 1 wherein the article is the blisterpack.

10. The article of claim 1 wherein the article is the neck band.

11. The article of claim 1 wherein the article is the shrinkwrap, shrink sleeve, or both.

12. The article of claim 4 wherein the article is the tear tape.

13. The article of claim 4 wherein the article is the blisterpack.

14. The article of claim 6 wherein the article is the neck band.

15. The article of claim 6 wherein the article is the shrinkwrap, shrink sleeve, or both.

16. A process comprising contacting a film with a marker wherein the contacting includes incorporating the marker into or onto the film by deposition, coating, dispersion, impregnation, lamination, or solubilization; the film comprises or is produced from a polymer including ethylene copolymer, polyolefin, polycarbonate, polyurethane, polyimide, polystyrene, polyester, polyamide, polymethacrylate, or combinations of two or more thereof; and the marker comprises nanoparticles including aluminum, chromium, gallium, indium, telluride, germanium, tin, antimony, a transition metal, or combinations of two or more thereof.

17. The process of claim 16 wherein the nanoparticle includes metal oxide, metal halide, metal carboxylate, metal nitrite, metal carbide, or even silicon oxide, silicon carbide, silicon nitrite, or combinations of two or more thereof.
